(19) United States
(12) Patent Application Publication
(10) Pub. No.: US 2025/0123631 A1
(43) Pub. Date: Apr. 17, 2025

(54) AUTONOMOUS MOBILE ROBOT AND OPERATING METHOD THEREOF

(71) Applicant: Delta Electronics Int’l (Singapore) Pte Ltd, Singapore (SG)

(72) Inventors: Chun-Lin Chen, Singapore (SG); Ying Song, Singapore (SG); Li Han Chen, Singapore (SG); Tzu-Yi Hung, Singapore (SG); Yongjun Wee, Singapore (SG); Qing Liu, Singapore (SG)

(21) Appl. No.: 18/910,574

(22) Filed: Oct. 9, 2024

Related U.S. Application Data
(60) Provisional application No. 63/543,586, filed on Oct. 11, 2023.

(51) Int. Cl. G05D 1/633; G05D 1/242; G05D 1/243; G05D 1/639; G10L 13/02

(52) U.S. Cl. CPC G05D 1/633; G05D 1/242; G05D 1/2437; G05D 1/642; G10L 13/02

(57) ABSTRACT

An autonomous mobile robot and an operating method thereof are provided. The autonomous mobile robot includes a movement module, a detection module, a control module and an interaction module. The control module includes a determination unit and a navigation unit. The determination unit determines whether there is an obstacle near or on a predetermined path of the autonomous mobile robot according to the environment information. When the obstacle is on the predetermined path, the navigation unit decides an obstacle avoidance strategy according to the environment information and the type of the obstacle. The obstacle avoidance strategy at least includes moving along a side path, stopping aside to yield, moving backward and stopping at a yielding point to yield, and detouring. When the obstacle is near or on the predetermined path, the interaction module performs an interaction action according to the obstacle avoidance strategy and the type of the obstacle.

### CROSS-REFERENCE TO RELATED APPLICATION

This application claims the benefit of U.S. Provisional Application No. 63/543,586 filed on Oct. 11, 2023 and entitled “HUMAN-CENTRIC SOCIAL ROBOT DESIGN”. The entire contents of the above-mentioned patent application are incorporated herein by reference for all purposes.

### FIELD OF THE INVENTION

The present disclosure relates to an autonomous mobile robot and an operating method thereof, and more particularly to an autonomous mobile robot and an operating method thereof capable of actively avoiding an obstacle on a predetermined path.

### BACKGROUND OF THE INVENTION

With the rapid development of technology, robots become more and more important in many fields, particularly in tasks that are highly repetitive, risky or require a high degree of precision. Nowadays, many industries have been starting to apply robots in fields having issues of labor shortages, such as the deliveries of meals, goods and medicines. In addition, robots also start to play a role in the healthcare field, especially in long-term care and visitation tasks. These applications not only reduce the burden on human labor but also improve work efficiency, and in some cases, robots may provide more consistent services than humans.

In environments that require frequent deliveries, such as hospitals, nursing homes or offices, robots can replace human labor in delivering meals or medicines. This not only reduces labor costs but also effectively lowers the risk of human error, which is especially critical in the delivery of medicines.

However, robots must first overcome the unique challenges of these environments, such as narrow corridors, complex pathways or the need to avoid pedestrians or equipment. Particularly, in environments with narrow pathways or high density of people, robots must possess capabilities of flexible path planning and real-time obstacle avoidance. For example, in a narrow corridor, the robot may need to actively slow down or yield to pedestrians to allow them to pass first.

In addition, in environments with many people who have limited mobility or are elderly, robots need to be able to recognize mobility aids such as canes and wheelchairs and perform more cautious avoidance actions accordingly. At the same time, robots should also exhibit some degree of politeness to make their behavior more human-like.

### SUMMARY OF THE INVENTION

The present disclosure provides an autonomous mobile robot and an operating method thereof. The autonomous mobile robot can actively perform avoidance actions when there is an obstacle near the autonomous mobile robot or on its path according to environment information. At the same time, the autonomous mobile robot performs appropriate interaction actions, which make the behavior of the autonomous mobile robot more polite and human-like.

In accordance with an aspect of the present disclosure, an autonomous mobile robot is provided. The autonomous mobile robot is capable to move in a building by using a preset map and includes a movement module, a detection module, a control module and an interaction module. The movement module is configured to enable the autonomous mobile robot to move. The detection module is configured to continuously detect environment information around the autonomous mobile robot. The control module is electrically connected to the movement module and the detection module, and is configured to control the movement module and the detection module. The movement module enables the autonomous mobile robot to move to a destination according to an instruction from the control module. The control module includes a determination unit and a navigation unit. The determination unit is configured to determine whether there is an obstacle near the autonomous mobile robot or on a predetermined path of the autonomous mobile robot according to the environment information detected by the detection module. The navigation unit is electrically connected to the determination unit. When the determination unit determines that there is an obstacle on the predetermined path of the autonomous mobile robot, the navigation unit decides an obstacle avoidance strategy according to the environment information and the type of the obstacle. The obstacle avoidance strategy at least includes moving along a side path, stopping aside to yield, moving backward and stopping at a yielding point to yield, and detouring. The interaction module is electrically connected to and controlled by the control module. When the determination unit determines that there is an obstacle near the autonomous mobile robot or on the predetermined path, the interaction module performs an interaction action according to the obstacle avoidance strategy and the type of the obstacle. The interaction action at least includes a voice prompt.

### BRIEF DESCRIPTION OF THE DRAWINGS

FIG. 1 is a schematic block diagram illustrating an autonomous mobile robot according to an embodiment of the present disclosure;

FIG. 2 is a schematic flow chart illustrating an operating method of the autonomous mobile robot according to an embodiment of the present disclosure;

FIG. 3, FIG. 4, FIG. 5, FIG. 6, FIG. 7, FIG. 8 and FIG. 9 exemplifies the obstacle avoidance strategies adopted by the autonomous mobile robot of the present disclosure under different application scenarios; and

FIG. 10 is a schematic block diagram illustrating the interaction module of FIG. 1 according to an embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only.

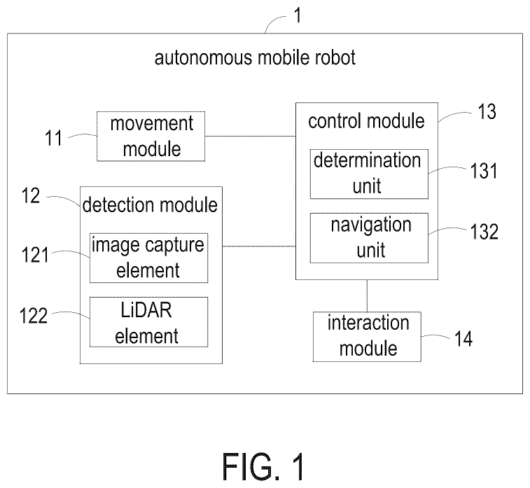

Please refer to FIG. 1. FIG. 1 is a schematic block diagram illustrating an autonomous mobile robot according to an embodiment of the present disclosure. As shown in FIG. 1, the autonomous mobile robot 1 is configured to move in a building by using a preset map, and the autonomous mobile robot 1 includes a movement module 11, a detection module 12, a control module 13 and an interaction module 14.

The movement module 11 is configured to enable movement of the autonomous mobile robot 1. The movement module 11 may include wheels, tracks or other moving components driven by a motor. In specific, the movement module 11 enables the autonomous mobile robot 1 to move to a destination according to instructions from the control module 13.

The detection module 12 is configured to continuously detect environment information around the autonomous mobile robot 1 so that the autonomous mobile robot 1 knows the terrain, obstacles, and the types, locations, moving trajectories and moving directions of the obstacles near the autonomous mobile robot 1 and on a predetermined path of the autonomous mobile robot 1 through the environment information obtained by the detection module 12. For example, the detection module 12 may include an image capture element 121 and/or a LiDAR (Light Detection and Ranging) element 122. The image capture element 121 is configured to capture images of the surroundings of the autonomous mobile robot 1. Correspondingly, when the detection module 12 includes the image capture element 121, the environment information obtained by the detection module 12 includes the images captured by the image capture element 121. The LiDAR element 122 is configured to generate high-precision 3D images by using optical technology. Correspondingly, in the embodiments that the detection module 12 includes the LiDAR element 122, the environment information obtained by the detection module 12 includes the 3D images generated by the LiDAR element 122. In some embodiments, the detection module 12 includes both the image capture element 121 and the LiDAR element 122, the image capture element 121 may be used as the primary detection element, while the LiDAR element 122 serving as an auxiliary detection element. For instance, under normal situations, the detection module 12 obtains the environment information around the autonomous mobile robot 1 through the image capture element 121, and in the condition that a confidence level of the image captured by the image capture element 121 is lower than a threshold (e.g., in low light or when the image cannot be recognized), the detection module 12 may switch to utilize the LiDAR element 122 to obtain environment information around the autonomous mobile robot 1.

The control module 13 is electrically connected to the movement module 11, the detection module 12 and the interaction module 14 and is configured to control the movement module 11, the detection module 12 and the interaction module 14. The control module 13 may be implemented by a suitable processor or microcontroller. During the process of the autonomous mobile robot 1 moving along the predetermined path to the destination, the control module 13 is configured to determine in real-time whether the path of the autonomous mobile robot 1 needs to be adjusted for avoidance according to the environment information detected by the detection module 12. In response to the avoidance being required, the control module 13 controls the movement module 11 and the interaction module 14 to perform corresponding actions. In this embodiment, the control module 13 includes a determination unit 131 and a navigation unit 132. The determination unit 131 is configured to determine whether there is an obstacle near the autonomous mobile robot 1 or on the predetermined path of the autonomous mobile robot 1 according to the environment information detected by the detection module 12. If there exists an obstacle, the determination unit 131 further determines the type of the obstacle (e.g., a person or an object such as a shoe rack, shoes or a door). The navigation unit 132 is electrically connected to the determination unit 131 and is configured to set the moving path of the autonomous mobile robot 1. When the determination unit 131 determines that there is an obstacle on the predetermined path of the autonomous mobile robot 1, the navigation unit 132 decides an obstacle avoidance strategy according to the environment information and the type of the obstacle, thereby allowing the autonomous mobile robot 1 to actively avoid the obstacle. The obstacle avoidance strategy at least includes moving along a side path, stopping aside to yield, moving backward and stopping at a yielding point to yield, and detouring. In the present disclosure, all movements of the autonomous mobile robot 1 are realized through controlling the movement module 11 by the navigation unit 132, and thus related details would be omitted in the following descriptions.

When executing the obstacle avoidance strategy of moving along a side path, the autonomous mobile robot 1 moves toward one side of the pathway to avoid the obstacle and continues to move to the destination (i.e., continues moving forward). When executing the obstacle avoidance strategy of stopping aside to yield, the autonomous mobile robot 1 moves toward one side of the pathway and stops to wait, and continues to move to the destination after the obstacle passes. When executing the obstacle avoidance strategy of moving backward and stopping at a yielding point to yield, the autonomous mobile robot 1 moves backward to a yielding point that allows the obstacle to pass, moves toward one side of the pathway then stops and waits, and continues to move to the destination after the obstacle passes. When executing the obstacle avoidance strategy of detouring, the autonomous mobile robot 1 changes its path to bypass the pathway where the obstacle is located and proceeds to the destination through another pathway.

When it is determined that there is an obstacle near the autonomous mobile robot 1 or on the predetermined path of the autonomous mobile robot 1, the interaction module 14 performs a corresponding interaction action according to the obstacle avoidance strategy decided by the navigation unit 132 and the type of the obstacle. The interaction action at least includes a voice prompt and/or a visual prompt. For example, when the navigation unit 132 decides to execute the obstacle avoidance strategy of moving along a side path and the obstacle is a person, the interaction module 14 may greet the person and inform the person that the autonomous mobile robot 1 is going to move to one side of the pathway then continue to move forward by the voice prompt. The interaction actions performed by the interaction module 14 depend on the specific implementation of the interaction module 14. For instance, the interaction module 14 may include an audio output element (e.g., a speaker) to provide voice prompts. Additionally, the interaction module 14 may include a display element (e.g., a screen) to show text and/or images.

Consequently, in the present disclosure, the autonomous mobile robot 1 can actively perform avoidance actions when there is an obstacle near the autonomous mobile robot 1 or on its path according to environment information. At the same time, the autonomous mobile robot 1 performs appropriate interaction actions, which make the behavior of the autonomous mobile robot 1 more polite and human-like.

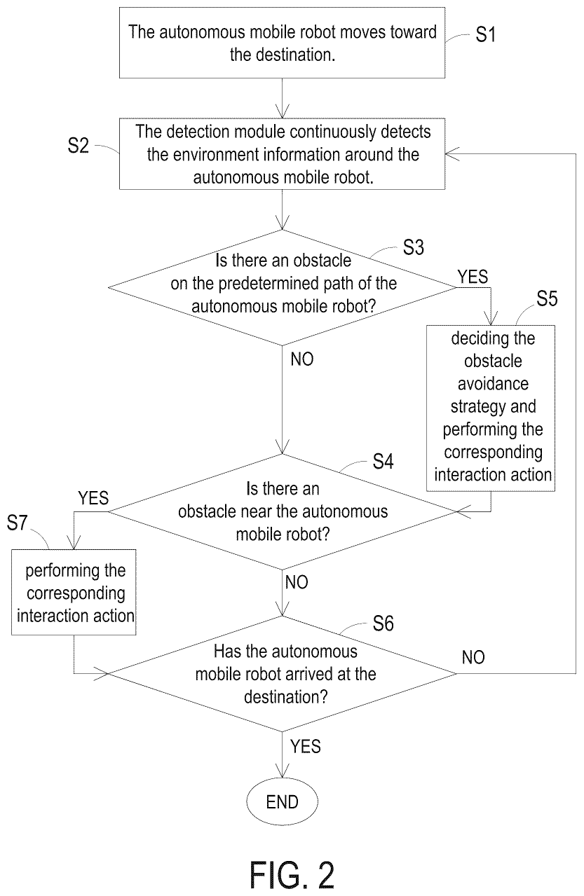

Please refer to FIG. 2 with FIG. 1. FIG. 2 is a schematic flow chart illustrating an operating method of the autonomous mobile robot according to an embodiment of the present disclosure. As shown in FIG. 2, the operating method of the autonomous mobile robot 1 includes the following steps. In step S1, the movement module 11 enables the autonomous mobile robot 1 to move toward the destination according to instructions from the control module 13. In step S2, the detection module 12 continuously detects the environment information around the autonomous mobile robot 1. In step S3, the determination unit 131 determines whether there is an obstacle on the predetermined path of the autonomous mobile robot 1 according to the environment information detected by the detection module 12. If the determination result of step S3 is negative, meaning that there is no obstacle on the predetermined path of the autonomous mobile robot 1, step S4 is performed. Conversely, if the determination result of step S3 is positive, meaning that there is an obstacle on the predetermined path of the autonomous mobile robot 1, step S5 is performed. In step S5, the navigation unit 132 decides the obstacle avoidance strategy according to the environment information and the type of the obstacle, and the interaction module 14 performs the corresponding interaction action according to the obstacle avoidance strategy and the type of the obstacle. After step S5, step S4 is performed.

In step S4, the determination unit 131 further determines whether there is an obstacle near the autonomous mobile robot 1 according to the environment information detected by the detection module 12. If the determination result of step S4 is negative, meaning that there is no obstacle near the autonomous mobile robot 1, step S6 is performed. Conversely, if the determination result of step S4 is positive, meaning that there is an obstacle near the autonomous mobile robot 1, step S7 is performed. In step S7, the interaction module 14 performs the corresponding interaction action according to the type of obstacle. After step S7, step S6 is performed.

In step S6, the control module 13 determines whether the autonomous mobile robot 1 has arrived at the destination. If the determination result of step S6 is positive, meaning that the autonomous mobile robot 1 has arrived at the destination, the process ends. Conversely, if the determination result of step S6 is negative, meaning that the autonomous mobile robot 1 has not reached the destination yet, step S2 is performed again. By continuously performing the steps S2, S3 and S4 on the way to the destination, the autonomous mobile robot 1 continuously detects the environment information and confirms whether there is an obstacle near it or on its predetermined path accordingly, and further performs the corresponding obstacle avoidance strategy and interaction action if the obstacle exists.

In the embodiments of the present disclosure, the autonomous mobile robot 1 may select an appropriate obstacle avoidance strategy according to the position and type of obstacle. For example, when there is a static obstacle on the predetermined path of the autonomous mobile robot 1, the autonomous mobile robot 1 may decide the moving path according to the position and size of the static obstacle and the distance between the static obstacle and two sides of the pathway, such as bypassing or detouring to another pathway. When there is a person on the predetermined path of the autonomous mobile robot 1, the autonomous mobile robot 1 may decide to stop aside to yield, move along a side path, move backward and stop at a yielding point to yield, or take another detouring path according to the type, moving direction and/or speed of the person. For example, if the person is an elderly individual with slower movement, the autonomous mobile robot 1 may decide to stop aside to yield, move along a side path, or take another detouring path according to the moving speed of the elderly person. In addition, if the person is an elderly individual using a mobility aid, the autonomous mobile robot 1 can decide to stop aside to yield, move along a side path, move backward and stop at a yielding point to yield, or take another detouring path according to the space occupied by the mobility aid on the pathway.

When there is a static obstacle near the autonomous mobile robot 1, the autonomous mobile robot 1 may decide the moving path according to the position and size of the static obstacle and the distance between the static obstacle and two sides of the pathway, such as bypassing or detouring to another pathway. Further, when there is also a person near the autonomous mobile robot 1, the autonomous mobile robot 1 may interact with the person through voice or other means to request the person to move away the static obstacle.

According to the obstacle avoidance principle of the autonomous mobile robot 1 in the present disclosure, when the obstacle on the predetermined path is a static object, the autonomous mobile robot 1 adjusts its path (moving along a side path or detouring) according to the position and width of the static object to proceed toward the destination. When the obstacle on the predetermined path is a dynamic obstacle and the autonomous mobile robot 1 is moving in the same direction as the dynamic obstacle, the autonomous mobile robot 1 would maintain a safe distance from the dynamic obstacle. Further, if the dynamic obstacle includes a person, the autonomous mobile robot 1 would not overtake the dynamic obstacle. Alternatively, when the autonomous mobile robot 1 and the dynamic obstacle are moving in opposite directions, the autonomous mobile robot 1 would proceed along a side path if the pathway is wide enough, and the autonomous mobile robot 1 would yield to the dynamic obstacle (e.g., by stopping at a side of pathway, moving backward and stopping at a yielding point to yield, or detouring) to allow the dynamic obstacle to pass first if the pathway is not wide enough. For example, the dynamic obstacle may include a person and/or a dynamic object, and the dynamic object is for example but not limited to an object pushed or held by people (e.g., a wheelchair or baby carriage pushed by a person, or a cane or walker held by a person), other living creatures (e.g., cats, dogs), or other autonomous mobile robots 1. Specifically, in an embodiment, when the obstacle on the predetermined path is a person using a mobility aid (e.g., a wheelchair or cane) and the autonomous mobile robot 1 and the person are moving in opposite directions, the autonomous mobile robot 1 would detour or move backward and stop at a yielding point to provide as much pathway space as possible for the person. Several application scenarios in which the autonomous mobile robot 1 selects the appropriate obstacle avoidance strategy according to the environment information and the type of obstacle are exemplified as follows. It is noted that the actual application scenarios are not limited to these examples, and even in the application scenarios not exemplified in the present disclosure, the autonomous mobile robot 1 is able to apply the foregoing obstacle avoidance principle to select the appropriate obstacle avoidance strategy.

When the determination unit 131 determines that there is a dynamic obstacle on the predetermined path, the navigation unit 132 obtains information of the width of the pathway on which the autonomous mobile robot 1 is located and the width and moving trajectory of the dynamic obstacle, according to the environment information. Then, the navigation unit 132 decides the obstacle avoidance strategy according to the width of the pathway, the width of the autonomous mobile robot 1, and the width and moving trajectory of the dynamic obstacle.

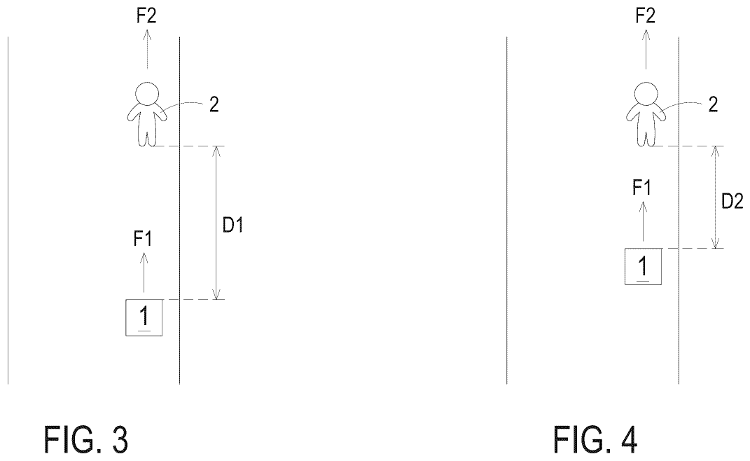

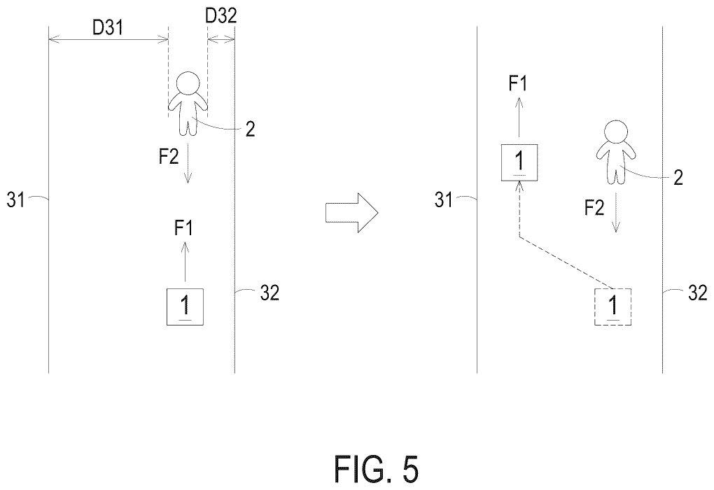

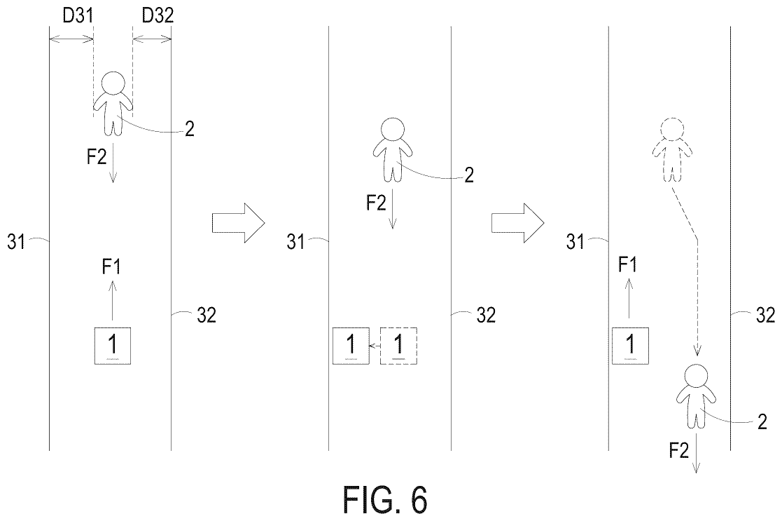

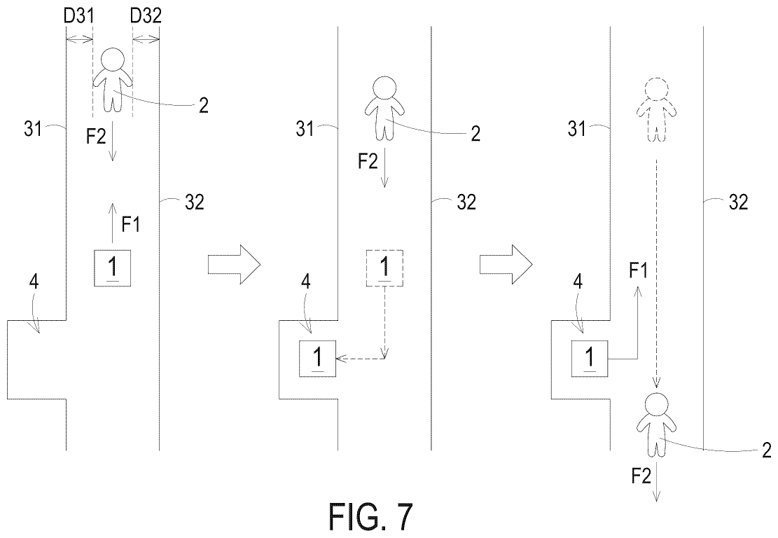

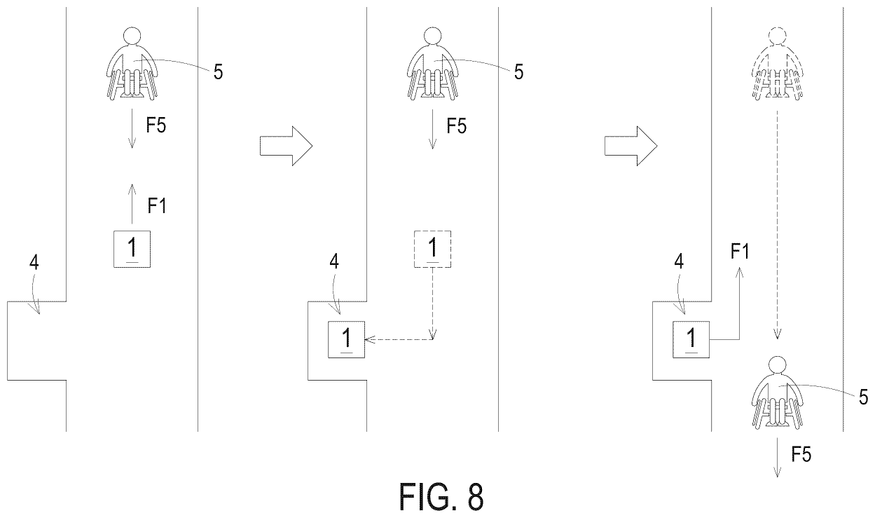

Please refer to FIG. 3. In FIG. 3, there is an obstacle on the predetermined path and the obstacle is a person 2, and a moving direction F2 of the person 2 is the same as a moving direction F1 of the autonomous mobile robot 1. Under this circumstance, the control module 13 controls the interaction module 14 to perform an interaction action (e.g., a voice prompt) to inform the person 2 of the moving direction FI of the autonomous mobile robot 1 when a distance between the autonomous mobile robot 1 and the person 2 is less than a predetermined distance D1. Moreover, if a speed of the autonomous mobile robot 1 is faster than a speed of the person 2, the distance between the autonomous mobile robot 1 and the person 2 would gradually decrease. As shown in FIG. 4, when the distance between the autonomous mobile robot 1 and the person 2 approaches a safe distance D2, the autonomous mobile robot 1 reduces its speed to maintain the distance between the autonomous mobile robot 1 and the person 2 to be greater than or equal to the safe distance D2. In addition, in an embodiment, if the speed of the person 2 is lower than a preset speed and the autonomous mobile robot 1 determines that continuing at this slow speed may affect the task that the autonomous mobile robot 1 is performing (e.g., causing a delay), the autonomous mobile robot 1 would change its path to proceed to the destination through another pathway.

Please refer to FIG. 5. In FIG. 5, there is an obstacle on the predetermined path and the obstacle is the person 2, and the moving direction F2 of the person 2 is opposite to the moving direction F1 of the autonomous mobile robot 1. Under this circumstance, if a distance between the person 2 and any one of two sides of the pathway is greater than a preset value, the autonomous mobile robot 1 moves to that side and continues toward the destination. The preset value is greater than the width of the autonomous mobile robot 1, which ensures that the autonomous mobile robot 1 is able to pass without getting too close to the person 2, and the preset value may be adjusted according to actual requirements. In the embodiment shown in FIG. 5, a distance D31 between the person 2 and a first side 31 of the pathway is greater than the preset value, while a distance D32 between the person 2 and the second side 32 is less than the preset value. Accordingly, the autonomous mobile robot 1 moves to the first side 31 of the pathway and continues toward the destination. Meanwhile, the control module 13 controls the interaction module 14 to perform an interaction action (e.g., a voice prompt) to inform the person 2 of the moving path of the autonomous mobile robot 1. The historical moving trajectory is depicted by dashed lines, as shown in FIG. 5.

Please refer to FIG. 6. In FIG. 6, there is an obstacle on the predetermined path and the obstacle is the person 2, and the moving direction F2 of the person 2 is opposite to the moving direction F1 of the autonomous mobile robot 1. Under this circumstance, if distances between the person 2 and two sides of the pathway are both less than the preset value, while the sum of the distances between the person 2 and two sides of the pathway is greater than the preset value, the autonomous mobile robot 1 moves to one side of the pathway and stop. Then, the autonomous mobile robot 1 utilizes the interaction module 14 to request the person 2 to pass between the autonomous mobile robot 1 and the other side of the pathway. The autonomous mobile robot 1 will wait for the person 2 to pass before continuing toward the destination. In the embodiment shown in FIG. 6, the distances D31 and D32 between the person 2 and two sides of the pathway are both less than the preset value, while the sum of the distances D31 and D32 is greater than the preset value. Therefore, the autonomous mobile robot 1 moves to the first side 31 of the pathway and stops, requests the person 2 to pass between the autonomous mobile robot 1 and the second side 32 of the pathway through the interaction module 14, and waits for the person 2 to pass. After the person 2 passes, the autonomous mobile robot 1 continues toward the destination. In this embodiment, the autonomous mobile robot 1 may decide which side of the pathway to move to for avoidance according to predetermined rules, predetermined determination conditions or the actual situation. For instance, the autonomous mobile robot 1 may consider traffic rules (e.g., prioritizing left or right), the distance between the autonomous mobile robot 1 or person 2 and the sides of the pathway, or the direction of the moving trajectory of person 2. In this example, the autonomous mobile robot 1 may move to the first side 31 of the pathway and remains stationary. The duration of remaining stationary may be a predetermined amount of time or may be determined according to the speed of the person 2. Alternatively, before resuming movement, the autonomous mobile robot 1 may wait until detecting that the person 2 has passed and the distance between the autonomous mobile robot 1 and the person 2 is greater than a predetermined distance.

Please refer to FIG. 7. In FIG. 7, there is an obstacle on the predetermined path and the obstacle is the person 2, and the moving direction F2 of the person 2 is opposite to the moving direction F1 of the autonomous mobile robot 1. Under this circumstance, if the sum of the distances between the person 2 and two sides of the pathway is less than the preset value, meaning that the pathway may be too narrow for the autonomous mobile robot 1 to stop and avoid the person 2, the autonomous mobile robot 1 moves backward and selects an appropriate yielding point on its previous path or in a nearby space. Once the autonomous mobile robot 1 reaches the yielding point, the autonomous mobile robot 1 moves to one side of the pathway and stops to wait, and continues toward the destination after the person 2 passes. At the yielding point, the width of the pathway is greater than a sum of the width of the person 2 and the preset value. In the embodiment shown in FIG. 7, the sum of the distances D31 and D32 between the person 2 and two sides of the pathway is less than the preset value. Therefore, the autonomous mobile robot 1 moves backward to a yielding point 4, then moves to the first side 31 of the pathway and stops to wait, then continues toward the destination after the person 2 passes. Simultaneously, the control module 13 controls the interaction module 14 to perform the interaction action (e.g., a voice prompt) to inform the person 2 of the moving path of the autonomous mobile robot 1. In an embodiment, the autonomous mobile robot 1 may search for a yielding point while moving backward. In other words, the autonomous mobile robot 1 continuously monitors the width of the pathway while moving backward, and the autonomous mobile robot 1 moves to one side for avoidance when the autonomous mobile robot 1 reaches a point where the width of the pathway exceeds the sum of the width of the person 2 and the preset value. Additionally, in an embodiment, a plurality of yielding points are predefined on the preset map to help the robot avoid the person 2. When the autonomous mobile robot 1 needs to adopt the obstacle avoidance strategy of moving backward and stopping at a yielding point, the autonomous mobile robot 1 moves backward to the yielding point that meets a predetermined condition. The predetermined condition may include that the yielding point is nearest to the autonomous mobile robot 1 and/or the yielding point is located at the previous moving path of the autonomous mobile robot 1.

Please refer to FIG. 8. In FIG. 8, there is an obstacle on the predetermined path and the obstacle is a person 5 using a mobility aid to move, and a moving direction F5 is opposite to the moving direction F1 of the autonomous mobile robot 1. Under this circumstance, the autonomous mobile robot 1 moves backward to the yielding point 4, moves to one side of the pathway and stop to wait, then continues toward the destination after the person 5 passes. Meanwhile, the control module 13 controls the interaction module 14 to perform the interaction action (e.g., a voice prompt) to inform the person 5 of the moving path of the autonomous mobile robot 1 and/or to remind the person 5 of noticing the presence and location of the autonomous mobile robot 1 by a voice or visual prompt. Similarly, the autonomous mobile robot 1 may search for a yielding point while moving backward, or the autonomous mobile robot 1 may directly move to a yielding point that meets the predetermined condition according to the preset map. In an embodiment, when the autonomous mobile robot 1 searches for a yielding point while moving backward, the autonomous mobile robot 1 would keep moving backward until an increase in the distance between the autonomous mobile robot 1 and one side of the pathway exceeds the preset value. At that point, the autonomous mobile robot 1 moves to that side of the pathway and stops, thereby allowing the person 5 to pass without change its moving path.

It is noted that when there is a person on the predetermined path of the autonomous mobile robot 1, the autonomous mobile robot 1 always informs the person of the moving path of autonomous mobile robot 1 while avoiding the person. In addition, when the person is near the autonomous mobile robot 1 but not on the predetermined path, the control module 13 controls the interaction module 14 to greet the person through performing the interaction action. Moreover, if the person is near the autonomous mobile robot 1 or on the predetermined path of the autonomous mobile robot 1, the autonomous mobile robot 1 slows down when the distance between the autonomous mobile robot 1 and the person is less than a first distance. Further, the autonomous mobile robot 1 would ensure that the distance between the autonomous mobile robot 1 and the person remains greater than a second distance, thereby avoiding collisions and enhancing safety. The first and second distances may be adjusted according to actual requirements (e.g., the type of building, the average pathway width and the operating mode of the robot).

When the determination unit 131 determines that there is an obstacle on the predetermined path and the obstacle is a static object, the navigation unit 132 obtains information of the width of the pathway on which the autonomous mobile robot 1 is located and the position and width of the static object from the environment information, and the navigation unit 12 decides the obstacle avoidance strategy according to the width of the pathway, the width of the autonomous mobile robot 1, and the position and width of the static object. In particular, if the remaining width of the pathway is sufficient for the autonomous mobile robot 1 to pass, the autonomous mobile robot 1 adopts the obstacle avoidance strategy of moving along a side path. On the contrary, if the remaining width of the pathway is insufficient for the autonomous mobile robot 1 to pass, the autonomous mobile robot 1 adopts the obstacle avoidance strategy of detouring.

In an embodiment, the building where the autonomous mobile robot 1 operates includes a plurality of floors. When there is an obstacle on the predetermined path and the autonomous mobile robot 1 determines, according to the preset map, the environment information and the type of obstacle, that no feasible obstacle avoidance strategy can be executed on the current floor (e.g., the remaining width of the pathway is insufficient for moving along a side path or stopping at a side of pathway, and there is no yielding point or other pathway on the current floor for executing the obstacle avoidance strategy of detouring or moving backward and stopping at a yielding point), the autonomous mobile robot 1 may proceed to the destination via another floor (e.g., by taking an elevator to another floor).

Additionally, in an embodiment, the interaction action performed by the interaction module 14 further includes having conversation. Under some special circumstances, the autonomous mobile robot 1 may start a conversation with a person to realize a certain obstacle avoidance strategy by cooperating with the person through the conversation. For example, as shown in FIG. 9, there is an obstacle on the predetermined path and the obstacle is a static object 61, the distances between the static object 61 and two sides of the pathway are both less than the preset value, and the sum of the distances between the static object 61 and two sides of the pathway is greater than the preset value. Under this circumstance, if the determination unit 131 determines that the static object 61 is movable and a person 62 is present near the autonomous mobile robot 1, the autonomous mobile robot 1 engages in a conversation with the person 62 to request the person 62 to assist in moving the static object 61 to either side of the pathway, thereby allowing the autonomous mobile robot 1 to pass.

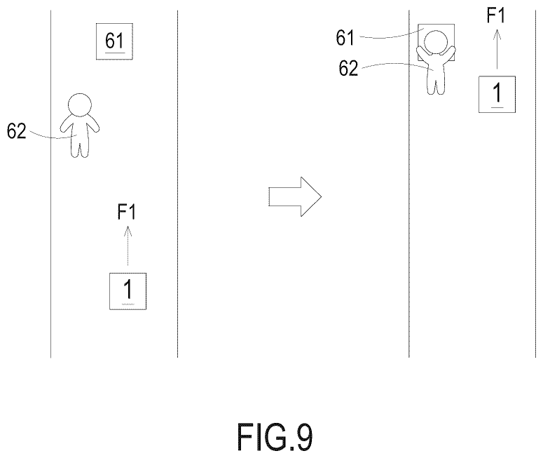

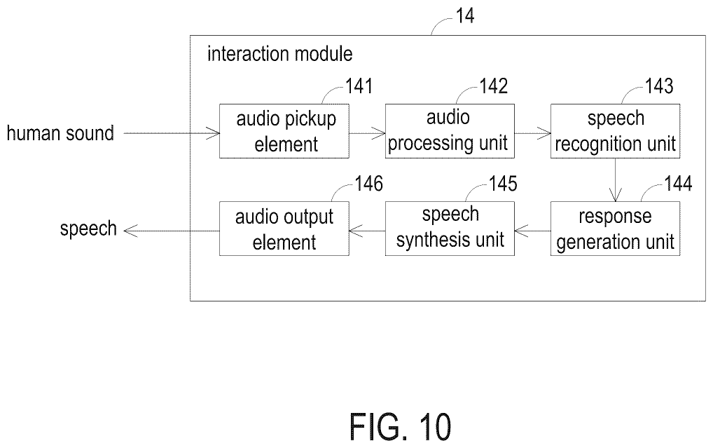

Please refer to FIG. 10. FIG. 10 is a schematic block diagram illustrating the interaction module of FIG. 1 according to an embodiment of the present disclosure. For allowing the interaction action performed by the interaction module 14 to include conversation, in an embodiment, as shown in FIG. 10, the interaction module 14 utilizes a language model to generate response content according to the person's speech, thereby realizing the conversation between the autonomous mobile robot 1 and the person. The language model may include a large language model (LLM) based on neural networks, but not limited thereto. The interaction module 14 includes an audio pickup element 141, an audio processing unit 142, a speech recognition unit 143, a response generation unit 144, a speech synthesis unit 145 and an audio output element 146. The audio pickup element 141 is configured to capture the sound made by the person and generate a corresponding sound signal. The audio pickup element 141 may include a microphone, but not exclusively. The audio processing unit 142 is connected to the audio pickup element 141 and is configured to process the sound signal (including but not limited to noise cancellation) generated by the audio pickup element 141. The speech recognition unit 143 is connected to the audio processing unit 142 and is configured to convert the sound signal processed by the audio processing unit 142 into a text content. For example, the speech recognition unit 143 may utilize the Whisper model to convert the sound signal into the text content. The response generation unit 144 is connected to the speech recognition unit 143 and is configured to generate a response text, based on the language model, for responding to the text content generated by the speech recognition unit 143. The speech synthesis unit 145 is connected to the response generation unit 144 and is configured to convert the response text generated by the response generation unit 144 into a sound signal. The audio output element 146 is connected to the speech synthesis unit 145 and is configured to play speech according to the sound signal generated by the speech synthesis unit 145.

In an embodiment, the response generation unit 144 includes an AI (artificial intelligence) chatbot, for example but not limited to ChatGPT. Through this AI chatbot, the autonomous mobile robot 1 can communicate with people and discuss feasible obstacle avoidance strategies according to the actual situation, without being limited to preset questions and answers. Accordingly, the applicability of the autonomous mobile robot 1 is enhanced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An autonomous mobile robot, capable to move in a building by using a preset map, and comprising:
a movement module, configured to enable the autonomous mobile robot to move;
a detection module, configured to continuously detect environment information around the autonomous mobile robot;
a control module, electrically connected to the movement module and the detection module, and configured to control the movement module and the detection module, wherein the movement module enables the autonomous mobile robot to move to a destination according to an instruction from the control module, and the control module comprises:
a determination unit, configured to determine whether there is an obstacle near the autonomous mobile robot or on a predetermined path of the autonomous mobile robot according to the environment information detected by the detection module; and
a navigation unit, electrically connected to the determination unit, wherein when the determination unit determines that there is the obstacle on the predetermined path of the autonomous mobile robot, the navigation unit decides an obstacle avoidance strategy according to the environment information and a type of the obstacle, and the obstacle avoidance strategy at least comprises moving along a side path, stopping aside to yield, moving backward and stopping at a yielding point to yield, and detouring; and
an interaction module, electrically connected to and controlled by the control module, wherein when the determination unit determines that there is the obstacle near the autonomous mobile robot or on the predetermined path, the interaction module performs an interaction action according to the obstacle avoidance strategy and the type of the obstacle, and the interaction action at least comprises a voice prompt.

2. The autonomous mobile robot according to claim 1, wherein when the determination unit determines that there exists the obstacle on the predetermined path and the obstacle is a dynamic obstacle, and a moving direction of the dynamic obstacle is the same as a moving direction of the autonomous mobile robot, the navigation unit obtains information of a speed of the dynamic obstacle according to the environment information, and the navigation unit adjusts a speed and a moving path of the autonomous mobile robot according to the speed of the dynamic obstacle, wherein the dynamic obstacle comprises a person and/or a dynamic object.

3. The autonomous mobile robot according to claim 2, wherein when the moving direction of the dynamic obstacle is the same as the moving direction of the autonomous mobile robot and the dynamic obstacle comprises the person, the control module controls the interaction module to perform the interaction action to inform the person of the moving direction of the autonomous mobile robot if a distance between the autonomous mobile robot and the person is less than a predetermined distance.

4. The autonomous mobile robot according to claim 2, wherein when the moving direction of the dynamic obstacle is the same as the moving direction of the autonomous mobile robot, the navigation unit controls the movement module to maintain a distance between the autonomous mobile robot and the dynamic obstacle to be greater than or equal to a safe distance.

5. The autonomous mobile robot according to claim 2, wherein when the moving direction of the dynamic obstacle is the same as the moving direction of the autonomous mobile robot and the speed of the dynamic obstacle is lower than a preset speed, the navigation unit controls the movement module to make the autonomous mobile robot proceed to the destination through another pathway.

6. The autonomous mobile robot according to claim 1, wherein when the determination unit determines that there exists the obstacle on the predetermined path and the obstacle is a dynamic obstacle, and a moving direction of the dynamic obstacle is opposite to a moving direction of the autonomous mobile robot, the navigation unit obtains information of a width of a pathway on which the autonomous mobile robot is located and a width of the dynamic obstacle according to the environment information, and the navigation unit decides the obstacle avoidance strategy according to distances between the dynamic obstacle and two sides of the pathway and a width of the autonomous mobile robot.

7. The autonomous mobile robot according to claim 6, wherein when the moving direction of the dynamic obstacle is opposite to the moving direction of the autonomous mobile robot and a distance between the dynamic obstacle and a first side of the two sides of the pathway is greater than a preset value, the navigation unit controls the movement module to make the autonomous mobile robot move to the first side of the two sides and continue toward the destination, wherein the preset value is greater than the width of the autonomous mobile robot.

8. The autonomous mobile robot according to claim 6, wherein in a situation that the moving direction of the dynamic obstacle is opposite to the moving direction of the autonomous mobile robot, the distances between the dynamic obstacle and the two sides of the pathway are both less than a preset value, and a sum of the distances between the dynamic obstacle and the two sides of the pathway is greater than the preset value, the navigation unit controls the movement module to make the autonomous mobile robot move to a first side of the two sides, stop to wait for the dynamic obstacle to pass, and continue toward the destination after the dynamic obstacle passes, wherein the preset value is greater than the width of the autonomous mobile robot.

9. The autonomous mobile robot according to claim 6, wherein when the moving direction of the dynamic obstacle is opposite to the moving direction of the autonomous mobile robot and a sum of the distances between the dynamic obstacle and the two sides of the pathway is less than the preset value, the navigation unit controls the movement module to make the autonomous mobile robot move backward until the width of the pathway is greater than a sum of the width of the dynamic obstacle and the preset value, move to a first side of the two sides of the pathway, stop to wait for the dynamic obstacle to pass, and continue toward the destination after the dynamic obstacle passes, wherein the preset value is greater than the width of the autonomous mobile robot.

10. The autonomous mobile robot according to claim 6, wherein a plurality of said yielding points are predefined on the preset map; when the moving direction of the dynamic obstacle is opposite to the moving direction of the autonomous mobile robot and a sum of the distances between the dynamic obstacle and the two sides of the pathway is less than the preset value, the navigation unit controls the movement module to make the autonomous mobile robot move backward to the yielding point which meets a predetermined condition, stop to wait for the dynamic obstacle to pass, and continue toward the destination after the dynamic obstacle passes, wherein the predetermined condition comprises that the yielding point is nearest to the autonomous mobile robot and/or the yielding point is located at a previous moving path of the autonomous mobile robot.

11. The autonomous mobile robot according to claim 1, wherein when the determination unit determines that there exists the obstacle on the predetermined path and the obstacle is a person using a mobility aid, and a moving direction of the person is opposite to a moving direction of the autonomous mobile robot, the navigation unit controls the movement module to make the autonomous mobile robot move backward until an increase in a distance between the autonomous mobile robot and a side of the pathway exceeds the preset value, move to the side of the pathway, stop to wait for the person to pass, and continue toward the destination after the person passes, wherein the preset value is greater than a width of the autonomous mobile robot.

12. The autonomous mobile robot according to claim 1, wherein a plurality of said yielding points are predefined on the preset map; when the determination unit determines that there exists the obstacle on the predetermined path and the obstacle is a person using a mobility aid, and a moving direction of the person is opposite to a moving direction of the autonomous mobile robot, the navigation unit controls the movement module to make the autonomous mobile robot move backward to the yielding point which meets a predetermined condition, stop to wait for the person to pass, and continue toward the destination after the person passes, wherein the predetermined condition comprises that the yielding point is nearest to the autonomous mobile robot and/or the yielding point is located at a previous moving path of the autonomous mobile robot.

13. The autonomous mobile robot according to claim 1, wherein when the determination unit determines that there exists the obstacle on the predetermined path and the obstacle is a static object,, the navigation unit obtains information of a width of a pathway on which the autonomous mobile robot is located, a position of the static object and a width of the static object from the environment information, and the navigation unit decides the obstacle avoidance strategy according to the width of the pathway, a width of the autonomous mobile robot and the position and the width of the static object.

14. The autonomous mobile robot according to claim 1, wherein when the determination unit determines that there exists the obstacle near the autonomous mobile robot or on the predetermined path and the obstacle is a person, the control module controls the interaction module to perform the interaction action to inform the person of a moving path of the autonomous mobile robot.

15. The autonomous mobile robot according to claim 1, wherein the building comprises a plurality of floors; when the determination unit determines that there exists the obstacle on the predetermined path and determines that no feasible obstacle avoidance strategy can be executed on a current floor of the plurality of floors according to the preset map, the environment information and a type of the obstacle, the navigation unit controls the movement module to make the autonomous mobile robot proceed to the destination via another floor of the plurality of floors.

16. The autonomous mobile robot according to claim 1, wherein the interaction action further comprises having conversation; when the determination unit determines that there exists the obstacle on the predetermined path and the obstacle is a static object, and distances between the static object and two sides of a pathway are both less than a preset value, and a sum of the distances between the static object and the two sides of the pathway is greater than the preset value, the interaction module engages in the conversation with a person to request the person to assist in moving away the static object for allowing the autonomous mobile robot to pass if the determination unit determines that the static object is movable and the person is present near the autonomous mobile robot, wherein the preset value is greater than a width of the autonomous mobile robot.

17. The autonomous mobile robot according to claim 16, wherein the interaction module comprises:
an audio pickup element, configured to capture sound made by the person and generate a sound signal accordingly;
an audio processing unit, connected to the audio pickup element and configured to process the sound signal generated by the audio pickup element;
a speech recognition unit, connected to the audio processing unit and configured to convert the sound signal processed by the audio processing unit into a text content;
a response generation unit, connected to the speech recognition unit and configured to generate a response text, based on a language model, for responding to the text content generated by the speech recognition unit;
a speech synthesis unit, connected to the response generation unit and configured to convert the response text generated by the response generation unit into a sound signal; and
an audio output element, connected to the speech synthesis unit and configured to play speech according to the sound signal generated by the speech synthesis unit.

18. The autonomous mobile robot according to claim 1, wherein the detection module comprises an image capture element configured to obtain the environment information around the autonomous mobile robot by capturing images.

19. The autonomous mobile robot according to claim 18, wherein the detection module further comprises a light detection and ranging element, when a confidence level of the images captured by the image capture element is lower than a threshold, the detection module utilizes the light detection and ranging element to obtain the environment information around the autonomous mobile robot.
